(19) United States
(12) Patent Application Publication
(10) Pub. No.: US 2020/0078894 A1
(43) Pub. Date: Mar. 12, 2020

(54) COOLANT FILTRATION SYSTEM

(71) Applicant: Manufacturing Productivity Systems, East Granby, CT (US)

(72) Inventors: Graham Noake, East Granby, CT (US); Brian Jalbert, East Granby, CT (US); Mike Sayers, East Granby, CT (US)

(21) Appl. No.: 16/563,090

(22) Filed: Sep. 6, 2019

Related U.S. Application Data
(60) Provisional application No. 62/728,335, filed on Sep. 7, 2018.

(51) Int. Cl. B23Q 11/10; B23Q 11/14; B23Q 11/12; B23Q 11/00

(52) U.S. Cl. CPC B23Q 11/1069; B23Q 11/0067; B23Q 11/122; B23Q 11/141

(57) ABSTRACT

A coolant filtration system including: a coolant tank including a first coolant zone and an adjacent second coolant zone; and a filtration system fluidly connected to the first coolant zone and the second coolant zone, the filtration system including an inlet located in the second coolant zone, an outlet located in the first coolant zone, a filter in fluid communication with the inlet and the outlet, and a pump that in operation pumps a coolant from the inlet in the second coolant zone to the filter such that a net positive flow of coolant is generated in the coolant tank from the first coolant zone to the second coolant zone.

### CROSS-REFERENCE TO RELATED APPLICATIONS

This application claims the benefit of U.S. Provisional Application No. 62/728,335 filed Sep. 7, 2018, which is incorporated herein by reference in its entirety.

### BACKGROUND

The subject matter disclosed herein relates to a coolant filtration system.

A machine may use a tool to form a workpiece through subtractive manufacturing that removes workpiece chips through various machining procedures. The machine may use a coolant to cool the workpiece, lubricate the machine tool, and wash away workpiece chips. Over time the coolant can become contaminated from workpiece chips, sludge, and other debris that makes the coolant less effective and shortens its useful life. Thus there remains a need for an improved method to remove debris from a coolant.

### BRIEF DESCRIPTION

Disclosed is a coolant filtration system including: a coolant tank including a first coolant zone and an adjacent second coolant zone; and a filtration system fluidly connected to the first coolant zone and the second coolant zone, the filtration system including an inlet located in the second coolant zone, an outlet located in the first coolant zone, a filter in fluid communication with the inlet and the outlet, and a pump that in operation pumps a coolant from the inlet in the second coolant zone to the filter such that a net positive flow of coolant is generated in the coolant tank from the first coolant zone to the second coolant zone.

Also disclosed is a machine including: a tool that in operation removes debris from a workpiece; and a coolant filtration system including a coolant tank including a first coolant zone and an adjacent second coolant zone fluidly connected to the first coolant zone, a filtration system fluidly connected to the first coolant zone and the second coolant zone, the filtration system including an inlet located in the second coolant zone, an outlet located into the first coolant zone, a filter including in fluid communication with the inlet and the outlet, and a pump that in operation pumps coolant from the inlet in the second coolant zone to the filter such that a net positive flow of coolant is generated in the coolant tank from the first coolant zone to the second coolant zone.

Also disclosed is a method of operating a coolant filtration system for a machine, the method including: pumping coolant through a coolant inlet disposed a first coolant zone of a coolant tank to a machine; capturing debris and coolant from the machine in a second coolant zone of the coolant tank, wherein the second coolant zone is adjacent to the first coolant zone; pumping coolant from the second coolant zone through an inlet of a filtration system, wherein the inlet of the filtration system is located within the second coolant zone; filtering the coolant with the filtration system; and returning coolant from the filtration system to the first coolant zone through an outlet of the filtration system such that a net positive flow of coolant is generated in the coolant tank from the first coolant zone to the second coolant zone.

Also disclosed is a coolant filtration system for use with a metal working machine, the coolant filtration system including: a coolant tank comprising a first coolant zone and a second coolant zone fluidly connected to the first coolant zone, wherein the second coolant zone is configured to receive debris and coolant from the metal working machine; a filtration system fluidly connected to the first coolant zone and the second coolant zone, the filtration system including: an inlet located in the second coolant zone, an outlet located in the first coolant zone, a filter in fluid communication with the inlet and the outlet, and a pump that in operation pumps coolant from the inlet in the second coolant zone to the filter system such that in operation a net positive flow of coolant is generated in the coolant tank from the first coolant zone to the second coolant zone; a first filter disposed above the second coolant zone, wherein the first filter in operation receives coolant and debris from the machine, captures debris of a defined first size within the first filter, and allows coolant to pass through the first filter; a collector located within the second coolant zone and below the first filter, wherein the collector in operation receives coolant and debris from the machine, and wherein the inlet of the filtration system is located within the collector and proximate to the bottom of the collector; and a vertical filter between the first coolant zone and the second coolant zone.

### BRIEF DESCRIPTION OF THE DRAWINGS

The following descriptions should not be considered limiting in any way. With reference to the accompanying drawings, like elements are numbered alike:

FIG. 1 illustrates an embodiment of a coolant filtration system;

FIG. 2 illustrates an embodiment of the coolant filtration system;

FIG. 3 illustrates an embodiment of the coolant filtration system;

FIG. 4 illustrates an embodiment of the coolant filtration system;

FIG. 5A illustrates an embodiment of the coolant filtration system;

FIG. 5B illustrates an embodiment of a flow straightener of the coolant filtration system;

FIG. 5C illustrates another embodiment of the flow straightener of the coolant filtration system; and

FIG. 6 is a flow chart of an embodiment of a method of operating the coolant filtration system.

### DETAILED DESCRIPTION

A detailed description of an embodiment of the disclosed apparatus and method are presented herein by way of exemplification and not limitation with reference to the Figures.

A machine may use a tool to form a workpiece through subtractive manufacturing that removes workpiece chips through various machining procedures. A coolant is used to cool the workpiece, lubricate the machine tool, and wash away workpiece chips. The coolant can become contaminated from workpiece chips, sludge, and other matter that makes the coolant less effective and shortens its useful life. The chips, sludge, and other matter can accumulate in a coolant tank and it can clog a screen, blind a filter, foul a pump, or reduce the volume of space in the tank available for coolant. Embodiments disclosed herein seek to address the accumulation of chips, sludge, and other matter in the coolant tank.

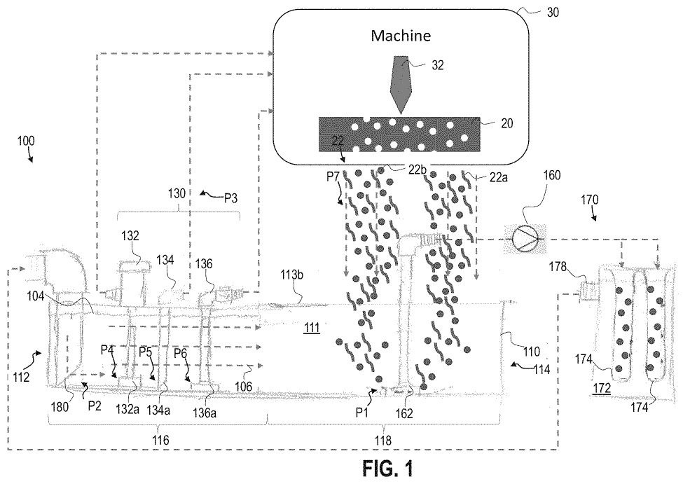

FIG. 1 schematically illustrates an embodiment of a coolant filtration system 100. The coolant filtration system 100 comprises a coolant tank 110 comprising a first coolant zone 116 and an adjacent a second coolant zone 118 within the coolant tank; and a filtration system 170 fluidly connected to the first coolant zone 116 and the second coolant zone 118, the filtration system 170 comprising an inlet 162 located in the second coolant zone 118, an outlet 180 located in the first coolant zone 116, a filter 174 in fluid communication with the inlet 162 and the outlet 180, and a pump 160 that in operation pumps coolant 104 from the inlet 162 in the second coolant zone 118 to the filtration system 170 such that a net positive flow of coolant 104 is generated in the coolant tank 110 from the first coolant zone 116 to the second coolant zone 118.

The coolant filtration system 100 can be used in conjunction with a machine 30 to filter debris 22 out of a coolant 104 used with the machine 30. The machine 30 may be any device suitable for the manufacture of articles from a workpiece 20 by subtractive manufacturing. The machine 30 may be a metalworking machine such as a vertical mill, such as a turret mill or a bed mill, or a horizontal mill. Representative machines include a computer numerical control (CNC) machine, a broaching machine, a honing machine, a lathe, a saw, a grinding machine, or the like. The coolant filtration system 100 can be retrofitted on an existing machine 30 or installed as part of the original equipment of the machine 30. A single coolant filtration system 100 can be used with a single machine 30, or the coolant filtration system can be used to support a plurality of machines. The machine 30 is provided coolant 104 via a coolant inlet, such as the first coolant inlet 132a as shown in FIG. 1.

The machine tool 32 of the machine 30 is used to machine a workpiece 20. The machine tool 32 removes debris 22 through a machining procedure that may increase a temperature of the workpiece 20 as material is removed creating debris 22. The machine 30 uses coolant 104 to cool and/or lubricate the workpiece 20, and wash away debris 22 from the workpiece 20 and/or machine tool 32.

The debris 22 may include material derived from the workpiece 20 being machined, material derived from the machine tool, material derived from the coolant 104, or combination thereof, and may comprise, for example, a particle, mill scale, paint, a shaving, dross, grinding sludge, or other foreign substance, disposed in the coolant 104. The debris 22 may include debris of various sizes and shapes, including first debris 22a and second debris 22b. The first debris 22 may have a dimension which is greater than a dimension of the second debris 22b. For example, first debris 22a may have a fibrous or ribbon shape, and second debris 22b may have spherical shape. Different filters may be utilized to separate or remove different configurations of the debris 22.

The coolant 104 may be aqueous or non-aqueous, and may comprise an emulsion. The coolant 104 may comprise an organic solvent, a fatty or petroleum oil, a soap, or a combination thereof, and may comprise an additive such as an antifoam agent, a preservative, a coupling agent, a corrosion inhibitor, a detergent, an anti-wear additive, a friction modifier, or a combination thereof. The organic solvent may comprise a C1 to C20 alcohol, a C1 to C20 ketone, a C1 to C20 nitrile, a C1 to C20 nitroalkane, a halogenated C1 to C20 alkane, or a combination thereof, each of which may be substituted with a branched, cyclic, or straight chain C1 to C20 alkyl group, e.g., an octyl, dodecyl, propyl, pentyl, hexyl, or cyclohexyl group. Representative ketones include acetone, cyclohexanone, and propanone. Representative nitro compounds include acetonitrile, propylnitrile, and octylnitrile. Examples of the halogenated alkane include methylene chloride, chloroform, tetrahaloethylene, and perhaloethane. The oil may be natural or synthetic, and may comprise a mineral oil. The coolant 104 may comprise a surfactant, wherein the surfactant may be anionic, cationic, or nonionic. Examples of suitable surfactants include alkali metal, ammonium, and amine soaps, wherein the fatty acid part of such soaps contains preferably at least 16 carbon atoms. A sulfonate, such as sodium cetyl sulfonate, or a sulfonated mineral oil can be used. A combination comprising at least one of the foregoing may be used.

The coolant 104 may have a viscosity may be between 50 Sabolt Universal Seconds (SUS) to 250 SUS, 60 SUS to 200 SUS, 70 SUS to 150 SUS, 80 SUS to 125 SUS, or 90 SUS to 114 SUS at 40° C. The coolant 104 may have a viscosity between 1×10⁻⁶ square meter per second (m²s⁻¹) to 1×10⁻⁴ m²s¹, 5×10⁻⁶ m²s⁻¹ to 5×10⁻⁵ m²s⁻¹, or about 1×10⁻⁵ m²s¹ at 40° C. A coolant 104 having a viscosity of 1 centistoke (cST) to 40 cST, 3 cST to 38 cST, 5 cST to 36 cST, 7 cST to 34 cST, or 10 cST to 32 cST at 40° C. is mentioned.

The coolant 104 used by the machine 30 and the debris 22 fall into a coolant tank 110 having a top 113b and located gravitationally below the machine 30. The top 113b may be open to allow debris 22 to fall into the coolant tank 110 through the top 113b. The coolant tank 110 has a first side 112 and a second side 114 opposite the first side 112 to form a basin 111. The coolant tank 110 may have any suitable shape and any suitable dimensions, may be rectilinear, and can have a rectangular shape as shown in FIG. 1.

The coolant tank 110 may include a first coolant zone 116 adjacent to the second coolant zone 118, wherein the first coolant zone 116 is proximate the first side 112 and a second coolant zone 118 is proximate the second side 114. As shown in FIG. 1, the second coolant zone 118 may be located gravitationally below the machine tool 32 in operation, such that coolant 104 used by the machine 30 and the debris 22 fall into the second coolant zone 118 of the coolant tank 110. When the coolant filtration system 100 is activated, a positive net flow 106 of coolant 104 is provided from the first coolant zone 116 to the second coolant zone 118, such that coolant 104 flows from the first coolant zone 116 to the second coolant zone 118. The positive net flow 106 of coolant 104 from the first coolant zone 116 to the second coolant zone 118 may be created by various methods including a net negative outflow of coolant 104 from the second coolant zone 118, a net positive inflow of coolant 104 to the first coolant zone 116, or a combination thereof.

The filtration system 170 may utilize a pump 160 that in operation pumps coolant 104 and debris 22 from inlet 162 in the second coolant zone 118 to the filter, whereby the filtered coolant 104 is returned to the first coolant zone 116 through the outlet 180 such that a net positive flow 106 of coolant 104 is generated from the first coolant zone 116 to the second coolant zone 118. The pump 160 may be located at any suitable location in the filtration system 170, such as, for example, proximate the inlet 162, between the inlet 162 and the filter 174, between the filter 174 and the outlet 180, or proximate to the outlet 180. In an embodiment, the pump 160 is located between the inlet 162 and the filter 174.

The pump 160 may be a centrifugal pump, a rotary lobe pump, a progressing cavity pump, a rotary gear pump, piston pump, a diaphragm pump, a screw pump, a gear pump, vane pump, or any other type of suitable fluid pump known to one of skill in the art.

The filtration system 170 may comprise any suitable filtration apparatus and employ any suitable filtration method. The filter 174 may be bag filter, a magnetic filter, a drum filtration device, or an automatic backwash filter. In an embodiment, the filter 174 comprises a bag filter, as shown in FIG. 1. The filter 174 may comprise any suitable filter media, such as woven or non-woven mesh, a screen, or a membrane, and may comprise any suitable material, such as a polymeric material, e.g., polyethylene, polypropylene, or a combination thereof, paper, or a metal such as aluminum, copper, steel, stainless steel, or a combination thereof. A combination comprising at least one of the foregoing materials can be used. Also, a filter aid, such as diatomaceous earth or a carbon, such as activated carbon, may be used. The filtration may be passive or active. For example, gravitational filtration or centrifugation may be used. Gravitational filtration through a bag filter is mentioned.

As shown in FIG. 1, the filtered coolant 104 is returned from the filtration system 170 to the coolant tank via the outlet in the first coolant zone 116. In an embodiment, the coolant 104 is returned to the first coolant zone 116 using a gravitational drain from the filter 174 to the outlet 180. For example, as shown in FIG. 1, the filtration system 170 may comprise a bag filter within a tub 172, which is fluidly connected to the outlet 180. After passing through the bag filter, the filtered coolant 104 from the tub 172 is directed to the coolant tank 110 via the outlet 180 to the first coolant zone 116.

While not wanting to be bound by theory, it is understood that due to the positive net flow 106 of coolant 104 from the first coolant zone 116 to the second coolant zone 118, debris 22 in the coolant 104, which may be floating or suspended in the coolant 104 flows towards the second coolant zone 118, directing the debris 22 away from a coolant inlet of a machine coolant pump and away from a vertical filter if present, avoiding fouling of the pump or blinding of the vertical filter.

The coolant filtration system 100 may further comprise a machine coolant pump 130 configured to provide filtered coolant 104 to the machine 30 to direct coolant 104 to the workpiece 20 to cool the machine tool 32 and/or provide lubrication to the machine tool 32. For example, the coolant filtration system 100 may comprise three machine coolant inlets and three machine coolant pumps, e.g., as shown in FIG. 1, a first machine coolant pump 132, a second machine coolant pump 134, and a third machine coolant pump 136. While three machine coolant inlets and three machine coolant pumps are shown in the example of FIG. 1, the coolant filtration system 100 may include any suitable number of machine coolant inlets and machine coolant pumps.

In an embodiment in which the machine coolant pumps are off, a first flow rate P1 at the inlet 162 to the filtration system 170 may be the same as a second flow rate P2 at the outlet 180, thereby providing the net positive flow 106 of coolant 104 from the first coolant zone 116 to the second coolant zone 118 of the coolant tank 110.

In an embodiment in which coolant 106 is used to provide coolant 104 to a machine 30, the coolant 106 being provided to the machine 30 and the filtration system 170 have a combined flow rate that is less than a flow rate of the outlet 180, thereby providing the net positive flow 106 of coolant 104 from the first coolant zone 116 to the second coolant zone 118 of the coolant tank 110. For example, a combined third flow rate P3 of coolant 104 to the machine 30 may be less than a second flow rate P2 at the outlet 180, thereby providing the net positive flow 106 of coolant 104 from the first coolant zone 116 to the second coolant zone 118 of the coolant tank 110. For example, the third flow rate P3 may be a total of coolant 106 flow from a first machine coolant pump 132 in fluid communication with an inlet 132a located within the first coolant zone 116 and having fourth flow rate P4, a second machine coolant pump 134 in fluid communication with an inlet 134a located within the first coolant zone 116 and having a fifth flow rate P5, and a third machine coolant pump 136 in fluid communication with an inlet 136a located within the first coolant zone 116 and having a sixth selected flow rate P6. The flow rates may be represented by Inequality (i), or Inequality (ii):

P2+(P4+P5+P6)>P1+P7 (ii)

P2+P3>P1+P7 (i)

For example, the first machine coolant pump 132 may be configured to pump coolant 104 out of the first coolant zone 116 at −20 gallons per minute (−76 liters per minute), the second machine coolant pump 134 may be configured to pump coolant 104 out of the first coolant zone 116 at −10 gallons per minute (−38 liters per minute), and the third machine coolant pump 136 may be configured to pump coolant 104 out of the first coolant zone 116 at about −10 gallons per minute (−38 liters per minute), thus the third flow rate P3 would be −40 gallons per minute (−151 liters per minute), and using a second flow rate P2 of 60 gallons per minute (227 liters per minute) would provide a net positive flow of 20 gallons per minute of coolant 104 from the first coolant zone 116 to the second coolant zone 118. The positive net flow 106 of coolant 104 prevents debris 22 from entering the first coolant zone 116.

Advantageously, the positive net flow 106 of coolant 104 from the first coolant zone 116 from the second coolant zone 118 prevents debris 22 from entering the first coolant zone 116 when the coolant filtration system 100 is in operation. Also advantageously, a filtration device may be operably associated with the second coolant zone 118 since debris 22 are located in second coolant zone 118.

When activated, the coolant filtration system 100 may continuously circulate and filter coolant 104 coming from the machine 30, and then feed the filtered coolant 106 back to the machine 30. In this way, the coolant filtration system 100 provides coolant 104 that is more effective and has a longer life as compared to coolant 104 that is not filtered, and as compared to coolant that is not filtered in the same way as that furnished by the coolant filtration system 100.

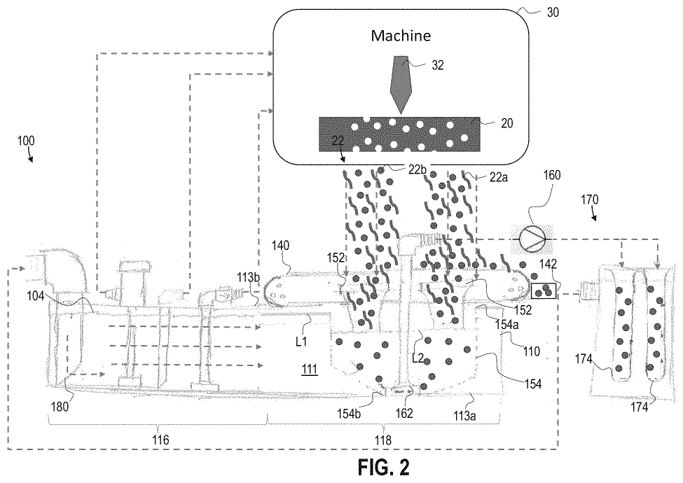

Referring now to FIG. 2 with continued reference to FIG. 1, the coolant filtration system 100 may incorporate an additional filtration apparatus and methods in addition to filtration system 170. As shown in FIG. 2, a conveyor 140 may be used to remove debris 22 from the coolant 104, a first filter 152 to in operation filter debris 22 of a defined first size from the coolant 104, and a collector 154 (e.g., a filter, basket, or funnel) to in operation filter debris 22 of a defined second size from the coolant 104. The collector 154 may be located at least partially below the first filter 152. The second size of debris 22 may be different than the first size. In some cases, the coolant 104 and debris 22 may be subjected to only some of the filtration apparatuses or may be subjected to the filtration apparatuses in different orders than described below, and in other cases, the coolant is subjected to all of the filtration apparatus in sequence, in parallel, or in some combination of both.

The conveyor 140 may be located between the machine 30 and the second coolant zone 118, such that as the machine tool 32 machines the workpiece 20 and removes debris 22, the debris 22 will fall onto the conveyor 140 to be transported to a debris collector 142 (e.g., a chip collector). The conveyor 140 may be a belt conveyer, a paper conveyor, or any other conveyer known to one of skill in the art. The first filter 152 may be located between the conveyor 140 and the second coolant zone 118 of the basin 111, such that debris 22 that falls through and/or around the conveyor 140 falls into the first filter 152. Coolant 104 falling from the machine 30 may fall through and/or around the conveyor 140 and into the first filter 152. The first filter 152 in operation captures debris 22 of a first size within the first filter 152 and allows coolant 104 to pass through the first filter 152. In an embodiment, the first filter 152 may capture first debris 22a while allowing second debris 22b to pass through. Advantageously, capturing the first debris 22a and allowing the second debris 22b to pass through the first filter 152 may avoid clogging of the first filter 152 by the second debris 22b. The first filter 152 may have openings having an average size of 0.01 micrometer (μm) to 10,000 μm, 0.1 μm to 1000 μm, or 1 μm to 100 μm. In an embodiment, the first filter 152 has openings having an average size 0.5 centimeters.

The collector 154 may be located beneath the conveyer 140 and at least partially beneath the first filter 152. The collector 154 may be disposed within the second coolant zone 118 of the basin 111. Debris 22 that falls around the first filter 152 and/or debris 22 that are too small to be captured by the first filter 152 around the conveyor 140 falls into the collector 154. In an embodiment the collector has a funnel or conical shape. The collector 154 may be wider proximate to a top 154a of the collector 154 and then may gradually narrow towards the bottom 154b of the collector 154. The top 154a of the collector 154 may be disposed proximate the conveyor 140, as shown in FIG. 2. The inlet 162 of the filtration system 170 may be located within the collector 154 and proximate the bottom 154b of the collector 154, as shown in FIG. 2. The collector 154 in operation may direct debris 22 into the inlet 162 of the pump 160 through gravity and suction of the pump 160 at the inlet 162. The collector 154 may be solid or non-permeable, such that coolant 140 and debris 22 of any size may not flow through the collector 154. The collector 154 may be semi-permeable, such that coolant 140 may flow through the collector 154 while debris 22 of a defined second size may not. The collector 154 may have an opening having an average size of 0.01 micrometer (μm) to 10,000 μm, 0.1 μm to 1000 μm, or 1 μm to 100 μm. In an embodiment, the collector 154 has an opening having a size of 0.5 centimeters. The collector 154 may extend from a bottom 113a of the coolant tank 110, to level L1 near the top 113b of the coolant tank 110. The level L1 may be the level of the coolant within the coolant tank 110 outside of the collector 154.

The filter system 170 may be configured for pumping coolant 104 and debris 22 from the inside of the collector 154 at a higher flow rate than coolant 104 and debris 22 are being provided to the collector 154, thus a level L2 of coolant 104 within the collector 154 may be lower than a level L1 of coolant 104 outside of the collector 154 within the basin 111. Advantageously, this difference between the level L2 of coolant 104 within the collector 154 and the level L1 of coolant 104 outside of the collector 154 promotes movement of debris 22 in the coolant 104 in the basin 111 outside of the collector 154 to move towards the collector 154. Advantageously, the collector 154 traps debris 22 within the collector 154 (e.g., regardless of whether the pump 160 is on or off), thus allowing the pump 160 for the filter system 170 to be shut off and the filter 174 emptied.

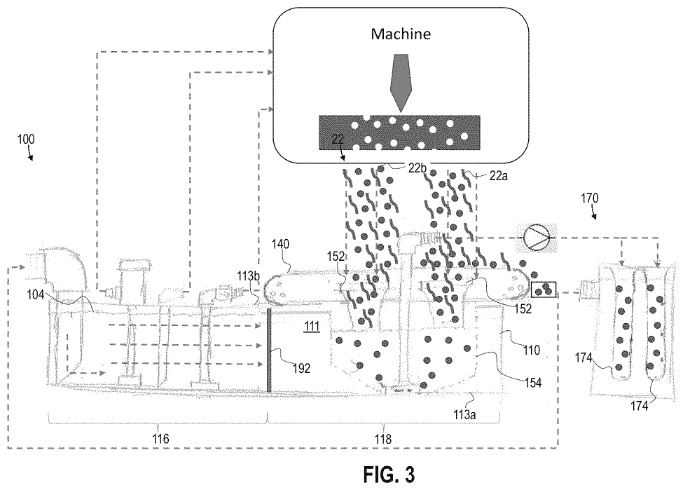

Referring now to FIG. 3, with continued reference to FIGS. 1-2, a vertical filter 192 for use with the filtration system 100 is illustrated. The vertical filter 192 may physically separate the first coolant zone 116 and the second coolant zone 118 of the basin 111. The vertical filter 192 may be located within the basin 111 and may extend from a top 113b to a bottom 113a of the coolant tank 110, as shown in FIG. 3, The vertical filter 192 may be semi-permeable, such that coolant 104 is allowed to pass through the vertical filter 192 but not debris 22 greater than a defined third size. The vertical filter 192 may be a mesh, a screen, a non-woven filter, a porous film, or any other suitable material known to one of skill in the art. The vertical filter may comprise a polymeric material, e.g., polyethylene, polypropylene, or a combination thereof, paper, or a metal such as aluminum, copper, steel, stainless steel, or a combination thereof. A combination comprising at least one of the foregoing materials can be used. An embodiment in which the vertical filter is steel is mentioned. The vertical filter 192 may include an opening having an average size, diameter, between 1 micrometer (μm) to 10 cm, 10 μm to 5 cm, or 0.1 cm to 1 cm. An embodiment in which the vertical filter has openings having an average size of 1 cm is mentioned. Advantageously, the vertical filter 192 traps debris 22 within second coolant zone 118 (e.g., regardless of whether the pump 160 is on or off), thus allowing the pump 160 for the filter system 170 to be shut off and the filter 174 emptied. In an embodiment, the coolant filtration system 100 may utilize the vertical filter 192 alone without the conveyor 140, the first filter 152, or the collector 154. In another embodiment, the coolant filtration system 100 may utilize the vertical filter 192 with at least one of the conveyor 140, the first filter 152, and the collector 154.

Advantageously, the positive net flow 106 helps remove of debris 22 (e.g., chips, sludge, and other matter) that can accumulate in a coolant tank 110 of a machine 30 where it can clog screens, foul pumps and reduce the volume of space in the tank available for coolant 104. Furthermore, a coolant filtration system 100 incorporating the positive net flow 106 of coolant 104 from the first coolant zone 116 to the second coolant zone 118 and the vertical filter 192 acts as a double fault system providing at improved protection relative to a single fault system against ingesting debris 22 into the machine 30. For example, if the positive net flow 106 were to cease then the vertical filter 192 would still prevent migration of debris 22 from the first coolant zone 116 to the second coolant zone 118. Alternatively, if the vertical filter 192 were to be removed, then the positive net flow 106 would still prevent migration of debris 22 from the first coolant zone 116 to the second coolant zone 118. Advantageously, having a double fault system increases the reliability of the coolant filtration system 100 and reduce overall maintenance of the coolant filtration system 100, thus helping to protect and preserve an expensive machine.

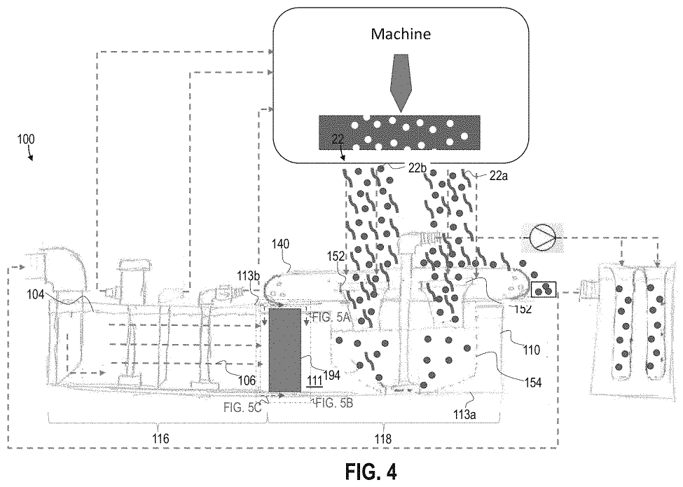

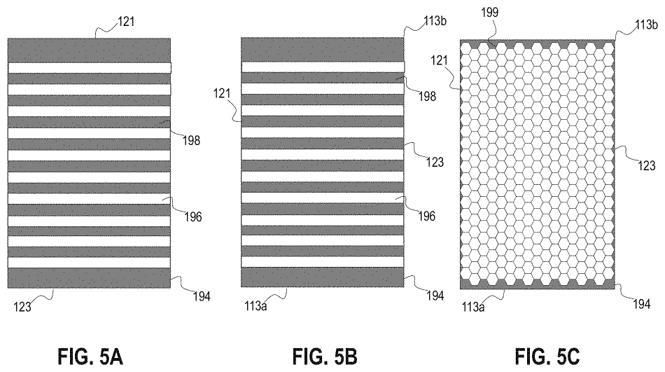

Referring now to FIGS. 4, 5A, 5B, and 5C, with continued reference to FIGS. 1-3, an embodiment of a flow straightener for use with the filtration system 100 is illustrated. The coolant filtration system 100 may incorporate a flow straightener 194 that may be located in the first coolant zone 116, in the second coolant zone 118, between the first coolant zone 116 and the second coolant zone 118, or a combination thereof. The flow straightener 194 may extend from a top 113b of the coolant tank 110 to a bottom 113a of the coolant tank 110, as shown in FIG. 4. The flow straightener 194 may comprise a passageway 196 that in operation straightens the positive net flow 106 of coolant 104 from the first coolant zone 116 to the second coolant zone 118. As shown in FIG. 5A, the passageway 196 may be oriented parallel to a first side wall 121 of the coolant tank 110 and a second side wall 123 of the coolant tank 110. The passageway 196 may be defined by a baffle 198. As shown in FIG. 5B, the passageway 196 may be oriented parallel to the top 113b of the coolant tank 110 and the bottom 113a of the coolant tank 110. The passageway 196 may be formed by baffle 198. As shown in FIG. 5C, flow straightener 194 may comprise a through hole 199. The through hole 199 may have any suitable shape, and may be rectilinear or curvilinear in cross-section, e.g., square or round in cross-section, or may be hexagonally shaped. In an embodiment, the coolant filtration system 100 may utilize the flow straightener 194 with at least one of the conveyor 140, the first filter 152, and the collector 154. Advantageously, the flow straightener 194 may help prevent turbulence within the basin 111 that may push debris 22 from the second coolant zone 118 to the first coolant zone 116.

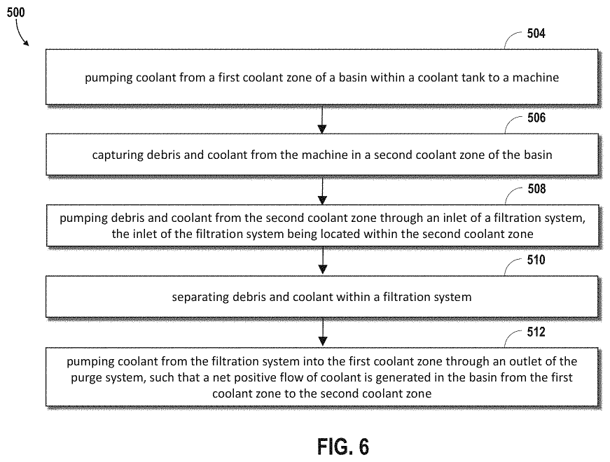

Referring now to FIG. 6 with continued reference to FIGS. 1-4, 5A, 5B, and 5C, FIG. 6 shows a method 500 of operating a coolant filtration system 100 for a machine 30, in accordance with an embodiment of the present disclosure. At block 504, coolant 104 is pumped from a first coolant zone 116 of a basin 111 within a coolant tank 110 to a machine 30. The coolant 140 may be pumped using the machine coolant pump 130. At block 506, debris 22 and coolant 104 from the machine 30 are captured in a second coolant zone 118. As mentioned above, the second coolant zone 118 is fluidly connected to the first coolant zone 116.

At block 508, debris 22 and coolant 104 are pumped from the second coolant zone 118 through an inlet 162 of a filtration system 170, the inlet 162 of the filtration system 170 being located within the second coolant zone 118. At block 510, the debris 22 and coolant 104 are separated within a filtration system 170. At block 512, coolant 104 is pumped from the filtration system 170 into the first coolant zone 116 through an outlet 180 of the filtration system 170, such that a net positive flow 106 of coolant 104 is generated from the first coolant zone 116 to the second coolant zone 118.

While the above description has described the flow process of FIG. 6 in a particular order, it should be appreciated that the ordering of the steps may be varied.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A coolant filtration system comprising:
a coolant tank comprising a first coolant zone and an adjacent second coolant zone; and
a filtration system fluidly connected to the first coolant zone and the second coolant zone, the filtration system comprising
an inlet located in the second coolant zone,
an outlet located in the first coolant zone,
a filter in fluid communication with the inlet and the outlet, and
a pump that in operation pumps a coolant from the inlet in the second coolant zone to the filter such that a net positive flow of coolant is generated in the coolant tank from the first coolant zone to the second coolant zone.

2. The coolant filtration system of claim 1, wherein in operation the coolant tank receives debris and coolant from a machine.

3. The coolant filtration system of claim 2, wherein the machine is a metal working machine.

4. The coolant filtration system of claim 1, wherein the filter comprises a bag filter.

5. The coolant filtration system of claim 1, wherein in operation the filtration system receives debris and coolant at the inlet and delivers filtered coolant at the outlet.

6. The coolant filtration system of claim 1, further comprising a vertical filter between the first coolant zone and the second coolant zone.

7. The coolant filtration system of claim 6, where the vertical filter has a pore size of 1 micrometer to 1 centimeter.

8. The coolant filtration system of claim 1, further comprising a flow straightener disposed in the first coolant zone, the second coolant zone, or a combination thereof, wherein in operation the flow straightener straightens the positive net flow of coolant.

9. The coolant filtration system of claim 8, wherein the flow straightener comprises a through hole.

10. The coolant filtration system of claim 8, wherein the flow straightener comprises a baffle.

11. The coolant filtration system of claim 1, further comprising a conveyor located above the coolant tank, wherein the conveyor in operation receives debris from the machine and transports the debris to a debris collector.

12. The coolant filtration system of claim 1, further comprising a first filter located above the second coolant zone, wherein the first filter in operation receives coolant and debris from the machine, captures debris of a defined first size within the first filter, and allows coolant to pass through the first filter.

13. The coolant filtration system of claim 1, further comprising:
a collector located within the second coolant zone, wherein the collector in operation receives coolant and debris from the machine, and
wherein the inlet of the filtration system is located within the collector and proximate to a bottom of the collector.

14. The coolant filtration system of claim 1, further comprising a machine coolant pump that is in fluid communication with a coolant inlet located within the first coolant zone, wherein in operation the machine coolant pump provides coolant from the first coolant zone to a machine.

15. A machine comprising:
a tool that in operation removes debris from a workpiece; and
a coolant filtration system comprising:
a coolant tank comprising a first coolant zone and an adjacent second coolant zone fluidly connected to the first coolant zone,
a filtration system fluidly connected to the first coolant zone and the second coolant zone, the filtration system comprising
an inlet located in the second coolant zone,
an outlet located into the first coolant zone,
a filter comprising in fluid communication with the inlet and the outlet, and
a pump that in operation pumps coolant from the inlet in the second coolant zone to the filter such that a net positive flow of coolant is generated in the coolant tank from the first coolant zone to the second coolant zone.

16. The machine of claim 15, wherein the filter comprises a bag filter.

17. The machine of claim 15, further comprising a vertical filter between the first coolant zone and the second coolant zone.

18. The machine of claim 15, further comprising a flow straightener disposed in the first coolant zone, the second coolant zone, or a combination thereof that in operation straightens the positive net flow of coolant.

19. The machine of claim 18, wherein the flow straightener comprises a through hole.

20. The machine of claim 15, further comprising:
a conveyor located above the coolant tank, wherein the conveyor in operation receives debris from the machine and transports the debris to a debris collector.

21. The machine of claim 15, further comprising:
a first filter located above the second coolant zone, wherein the first filter in operation receives coolant and debris from the machine, captures debris of a defined first size within the first filter, and allows coolant to pass through the first filter.

22. The machine of claim 15, further comprising:
a collector located within the second coolant zone, wherein the collector in operation receives coolant and debris from the machine, and
wherein the inlet of the filtration system is located within the collector and proximate the bottom of the collector.

23. The machine of claim 15, further comprising:
a machine coolant pump that is in fluid communication with a coolant inlet located within the first coolant zone, wherein in operation the machine coolant pump provides coolant from the first coolant zone to the machine.

24. The machine of claim 15, wherein the second coolant zone is located gravitationally below the machine tool.

25. A method of operating a coolant filtration system for a machine, the method comprising:
pumping coolant through a coolant inlet disposed in a first coolant zone of a coolant tank to a machine;
capturing debris and coolant from the machine in a second coolant zone of the coolant tank, wherein the second coolant zone is adjacent to the first coolant zone;
pumping coolant from the second coolant zone through an inlet of a filtration system, wherein the inlet of the filtration system is located within the second coolant zone;
filtering the coolant with the filtration system; and
returning coolant from the filtration system to the first coolant zone through an outlet of the filtration system such that a net positive flow of coolant is generated in the coolant tank from the first coolant zone to the second coolant zone.

26. The method of claim 25, wherein the filtration system comprises a filter which is in fluid communication with the inlet and the outlet

27. The method of claim 25, wherein a flow rate of the coolant inlet is less than a flow rate of the outlet of the filtration system.

28. The method of claim 25, wherein the coolant inlet comprises a plurality of coolant inlets, and
wherein a total flow rate of the plurality of coolant inlets is less than a flow rate of the outlet of the filtration system.

29. A coolant filtration system for use with a metal working machine, the coolant filtration system comprising:
a coolant tank comprising a first coolant zone and a second coolant zone fluidly connected to the first coolant zone, wherein the second coolant zone is configured to receive debris and coolant from the metal working machine;
a filtration system fluidly connected to the first coolant zone and the second coolant zone, the filtration system comprising
an inlet located in the second coolant zone,
an outlet located in the first coolant zone,
a filter in fluid communication with the inlet and the outlet, and
a pump that in operation pumps coolant from the inlet in the second coolant zone to the filter system such that in operation a net positive flow of coolant is generated in the coolant tank from the first coolant zone to the second coolant zone;
a first filter disposed above the second coolant zone, wherein the first filter in operation receives coolant and debris from the machine, captures debris of a defined first size within the first filter, and allows coolant to pass through the first filter;
a collector located within the second coolant zone and below the first filter, wherein the collector in operation receives coolant and debris from the machine, and wherein the inlet of the filtration system is located within the collector and proximate to the bottom of the collector; and
a vertical filter between the first coolant zone and the second coolant zone.
